(19) United States
(12) Patent Application Publication
(10) Pub. No.: US 2019/0254058 A1
(43) Pub. Date: Aug. 15, 2019

(54) DATA TRANSMISSION METHOD AND APPARATUS

(71) Applicant: ZTE CORPORATION, Shenzhen, Guangdong (CN)

(72) Inventors: Saijin XIE, Shenzhen (CN); Wei GOU, Shenzhen (CN); Peng HAO, Shenzhen (CN); Feng BI, Shenzhen (CN)

(21) Appl. No.: 16/323,054

(22) PCT Filed: Jul. 18, 2017
(86) PCT No.: PCT/CN2017/093387

§ 371 Date: May 6, 2019

(30) Foreign Application Priority Data
Aug. 12, 2016 (CN) 201610666067.8

(51) Int. Cl. H04W 72/12; H04L 5/00; H04W 72/14; H04W 72/04

(52) U.S. Cl. CPC H04W 72/1289; H04W 72/0446; H04W 72/14; H04L 5/0048

(57) ABSTRACT

Provided are a data transmission method and a data transmission apparatus. The data transmission method includes: a base station determining that a traffic type 2 needs to preempt a resource in a scheduling time interval of a traffic type 1; and when transmitting the traffic type 1 and the traffic type 2 on a same carrier frequency in a multiplexing manner, the base station sending a signal for indicating a resource position of the traffic type 2.

### TECHNICAL FIELD

The present disclosure relates to, but is not limited to, wireless communication technologies, and, in particular, relates to a data transmission method and a data transmission apparatus.

### BACKGROUND

Many requirements of the new radio access technology (RAT) are considered based on services and scenarios. The design of the frame structure needs to consider user equipments of different frequency bands, different scenarios, and different requirements. Different numerologies and different transmission time interval (TTI) lengths can be multiplexed on the same carrier, such as multiplexed in the manner of frequency division multiplexing (FDM) and/or time division multiplexing (TDM).

Common services generally include three types: enhanced mobile broadband (eMBB) service, ultra-reliable and low latency communications (URLLC) service, and massive machine type communications (mMTC) service. Different services have different requirements for latency, coverage and reliability. The eMBB service has a higher requirement on high peak transmission rate, a lower requirement on latency, and a middle requirement on reliability. The URLLC service has a higher requirement on low latency and high reliability. The mMTC has a higher requirement on large connection density and coverage, and has a lower requirement on latency. Therefore, the eMBB service is applicable to be transmitted on a large bandwidth, and its subframe length is long. The URLLC traffic occurs occasionally and needs to be reliably transmitted and received in a short time, and is applicable to be transmitted on a large bandwidth and short scheduling time unit (which may be in units of time or in units of symbols). The mMTC service is applicable to be transmitted on narrow bandwidth and has a long scheduling time unit.

The URLLC traffic may be multiplexed with other traffic (referring to non-URLLC traffic here) in a manner of TDM. That is, the base station may interrupt other services being scheduled, and temporarily schedule the URLLC traffic on resources of other services. As shown in FIG. 1, it is assumed that the basic time interval used in scheduling various traffic is 7 symbols, and the basic time interval may be defined in units of symbols or defined by duration. Downlink control information (DCI) generally is transmitted on first few symbols of a scheduling time interval (a scheduling time unit). The scheduling time interval of the URLLC traffic is one basic time interval. After the URLLC traffic punctures other traffic, if UE of the other traffic does not know that the existence of the URLLC traffic, the reception, retransmission and merging as well as data reception and decoding of the UE will be influenced. For example, in the case where the UE of other traffic fails to decode, since the UE does not know the position of the URLLC traffic, it is very likely for the UE to perform a soft merging on data which is punctured. In addition, if the URLLC traffic occurs on a position of control signaling of other traffic, the UE of other traffic cannot detect the control signaling, and resources in the whole scheduling period will be wasted.

Therefore, in the related art, since the user equipment does not know that traffic scheduling resources corresponding to the equipment are punctured by the URLLC traffic, the data retransmission and merging and reception decoding may have errors.

### SUMMARY

The following is a summary of the subject matter described herein in detail. This summary is not intended to limit the scope of the claims.

The present disclosure provides a data transmission method and a data transmission apparatus, for ensuring the correct traffic reception of the user equipment of a traffic type 1 when part of resources of the traffic type 1 is preempted by a traffic type 2.

An embodiment of the present disclosure provides a data transmission method. The method includes:

determining, by a base station, that a traffic type 2 needs to preempt a resource in a scheduling time interval of a traffic type 1; and

when transmitting the traffic type 1 and the traffic type 2 on a same carrier frequency in a multiplexing manner, sending, by the base station, a signal for indicating a resource position of the traffic type 2.

An embodiment of the present disclosure further provides a data transmission method. The method includes:

determining, by a base station, that a traffic type 2 needs to preempt a resource in a scheduling time interval of a traffic type 1;

when transmitting the traffic type 1 and the traffic type 2 on a same carrier frequency in a multiplexing manner, scheduling, by the base station, traffic of the traffic type 2 on one or more basic time intervals in the scheduling time interval of the traffic type 1; and

after the traffic of the traffic type 2 is scheduled, sending, by the base station, control information and data of the traffic type 1 on resources after the resource position of the traffic type 2.

An embodiment of the present disclosure further provides a data transmission method. The method includes:

monitoring, by a UE of a traffic type 1, in a scheduling time interval, a signal that indicates a resource position of a traffic type 2 sent by a base station; and

in response to detecting the signal for indicating the resource position of the traffic type 2, determining, by the UE of the traffic type 1, the resource position of the traffic type 2 according to the signal that indicates the resource position of the traffic type 2.

The traffic type 2 preempts a resource in the scheduling time interval of the traffic type 1.

An embodiment of the present disclosure further provides a data transmission method. The method includes:

monitoring, by a UE of a traffic type 1, in a scheduling time interval, a signal that indicates a resource position of a traffic type 2 sent by a base station; and

in response to detecting position information of the traffic type 2, the UE of the traffic type 1 monitoring control information of the traffic type 1 on positions after the traffic type 2.

The traffic type 2 preempts resources in the scheduling time interval of the traffic type 1.

An embodiment of the present disclosure further provides a data transmission apparatus, which is applied in a base station. The apparatus includes:

a detection module, which is configured to determine that a traffic type 2 needs to preemptpreempts resources in a scheduling time interval of a traffic type 1; and

a resource position indication module, which is configured to, when the traffic type 1 and the traffic type 2 are multiplexed on a same carrier frequency for transmission, send a signal for indicating a resource position of the traffic type 2.

An embodiment of the present disclosure further provides a data transmission apparatus, applied in a base station. The apparatus includes:

a detection module, which is configured to determine that a traffic type 2 needs to preempt resources in a scheduling time interval of a traffic type 1; and

a traffic scheduling module, which is configured to, when the traffic type 1 and the traffic type 2 are multiplexed on a same carrier frequency for transmission, schedule traffic of the traffic type 2 on one or more basic time intervals within the scheduling time interval of the traffic type 1; and send, after the traffic of the traffic type 2 is scheduled, control information and data of the traffic type 1 on resources behind the resource position of the traffic type 2.

An embodiment of the present disclosure further provides a data transmission apparatus, applied in a UE of a traffic type 1. The apparatus includes:

a monitoring module, which is configured to, in a scheduling time interval, monitor a signal that indicates a resource position of a traffic type 2, where the signal is sent by a base station; and

a resource position determination module, which is configured to, in response to detecting the signal that indicates the resource position of the traffic type 2, determine the resource position of the traffic type 2 according to the signal that indicates the resource position of the traffic type 2; where the traffic type 2 preempts resources in the scheduling time interval of the traffic type 1.

An embodiment of the present disclosure further provides a data transmission apparatus, applied in a UE of a traffic type 1. The apparatus includes:

a first monitoring module, which is configured to monitor, in a scheduling time interval, a signal that indicates a resource position of a traffic type 2 sent by a base station; and

a second monitoring module, which is configured to, after position information of the traffic type 2 is detected, monitor control information of the traffic type 1 on positions after the traffic type 2.

The traffic type 2 preempts resources in the scheduling time interval of the traffic type 1.

In addition, an embodiment of the present disclosure further provides a computer-readable medium. The computer-readable medium stores programs for data transmission. When the programs are executed by a processor, the steps of the data transmission method described above are implemented.

Compared with the related art, according to the data transmission methods and apparatuses of the embodiments of the present disclosure, when the traffic type 2 preempts part of resources of the traffic type 1, the base station sends a signal for indicating a resource position of the traffic type 2, and the UE of the traffic type 1 acquires resource position information of the traffic type 2, thereby ensuring the correct decoding, retransmission and merging in the traffic reception. Alternatively, when the traffic type 2 preempts the resources of the traffic type 1, after the base station schedules traffic of the traffic type 2, the base station proceeds the transmission of control information and data of the traffic type 1, ensuring that the traffic of the traffic type 1 is received correctly by the UE of the traffic type 1.

Other aspects can be understood after the drawings and detailed description are read and understood.

### BRIEF DESCRIPTION OF DRAWINGS

FIG. 1 is a schematic diagram showing a scheduling time interval and a basic time interval in the related art;

FIG. 2 is a flowchart of a data transmission method according to an embodiment of the present disclosure (on a base station side);

FIG. 3 is a flowchart of a data transmission method according to an embodiment of the present disclosure (on a base station side);

FIG. 4 is a flowchart of a data transmission method according to an embodiment of the present disclosure (on a UE side);

FIG. 5 is a flowchart of a data transmission method according to an embodiment of the present disclosure (on a UE side);

FIG. 6 is a schematic diagram of a data transmission apparatus according to an embodiment of the present disclosure (on a base station side);

FIG. 7 is a schematic diagram of a data transmission apparatus according to an embodiment of the present disclosure (on a base station side);

FIG. 8 is a schematic diagram of a data transmission apparatus according to an embodiment of the present disclosure (on a UE side);

FIG. 9 is a schematic diagram of a data transmission apparatus according to an embodiment of the present disclosure (on a UE side);

FIG. 10 (a) is a schematic diagram of using a pilot signal as indication information of the resource position of the URLCC traffic according to an embodiment one of the present disclosure;

FIG. 10 (b) is a schematic diagram of using a pilot signal as indication information of the resource position of the URLCC traffic according to an embodiment two of the present disclosure;

FIG. 11 is a schematic diagram of using a pilot signal as indication information of the resource position of the URLCC traffic according to an embodiment three of the present disclosure;

FIGS. 12 (a), (b) and (c) are schematic diagrams showing different pilot signal positions according to the embodiment three of the present disclosure;

FIG. 13 is a schematic diagram of using a broadcast signal as indication information of the resource position of the URLCC traffic according to an embodiment four of the present disclosure;

FIG. 14 is a schematic diagram of using a broadcast signal as indication information of the resource position of the URLCC traffic according to an embodiment five of the present disclosure;

FIG. 15 is a schematic diagram of using a periodic pilot signal as indication information of the resource position of the URLCC traffic according to an embodiment six of the present disclosure;

FIG. 16 is a schematic diagram of using common DCI as indication information of the resource position of the URLCC traffic according to an embodiment seven of the present disclosure; and

FIG. 17 is a schematic diagram of using common DCI as indication information of the resource position of the URLCC traffic according to an embodiment nine of the present disclosure.

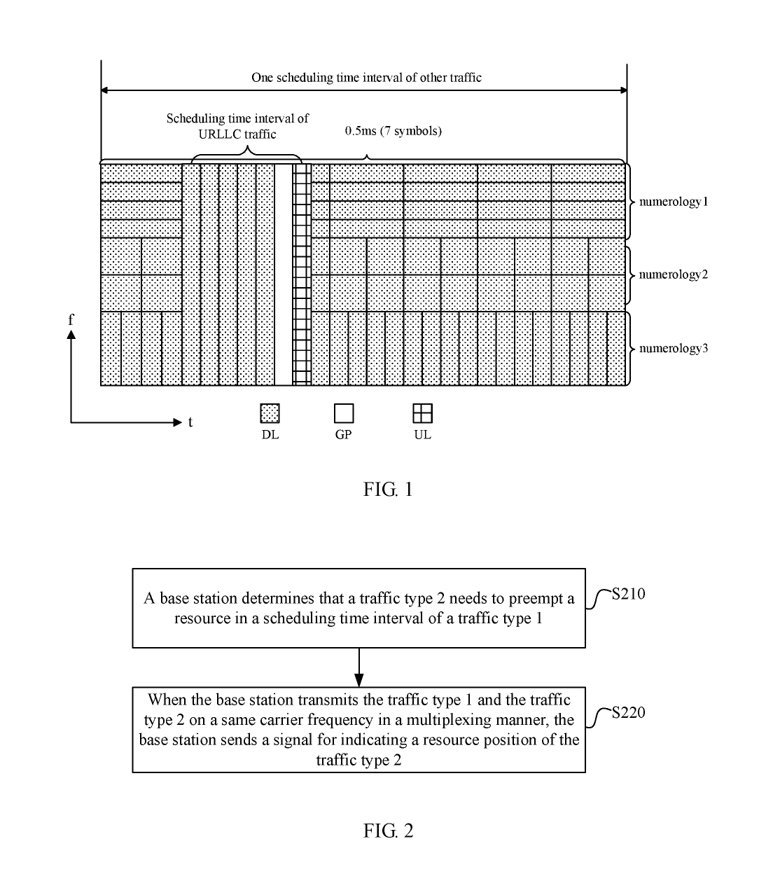

### DETAILED DESCRIPTION

Embodiments of the present disclosure will be described below in detail in conjunction with the drawings. It is to be noted that if not in collision, the embodiments and features therein in the present disclosure may be combined with each other.

A basic time interval described in the present disclosure may be a designated time length or a designated number of symbols.

A traffic type 1 described in the present disclosure may be traffic provided by an indoor hotspot, or macrocell traffic of intensive urban areas, villages and cities, or high speed traffic. A key performance indication (KPI) of the traffic type 1 is a large data peak rate, spectrum efficiency and coverage. The traffic type 1 does not have a high requirement on latency, and the data packet in a single transmission of the traffic type 1 is large. Therefore, the traffic type 1 needs multiple consecutive basic time intervals and a sufficient transmission bandwidth, the occurrence rate of the traffic type 1 is also relatively high.

A traffic type 2 described in the present disclosure requires very low latency and high data transmission reliability, and the data packet in a single transmission is relatively small. Therefore, the traffic type 2 may require a wider bandwidth and shorter scheduling latency. The traffic type 2 is sporadic and occurs irregularly, and the occurrence rate is not high. Therefore, it is difficult for a base station to predict the occurrence time of the traffic type 2.

Since the occurrence rate of the eMBB traffic is high, and the URLLC traffic occurs sporadically. Therefore, it may be assumed that the entire resources are for the eMBB traffic by default, and the URLLC traffic may be multiplexed on the resources of the eMBB traffic in a manner of puncturing.

As shown in FIG. 2, an embodiment of the present disclosure provides a data transmission method. The method includes the steps described below.

In step S210, a base station determines that a traffic type 2 needs to preempt a resource in a scheduling time interval of a traffic type 1.

In step S220, when the base station transmits the traffic type 1 and the traffic type 2 on a same carrier frequency in a multiplexing manner, the base station sends a signal for indicating a resource position of the traffic type 2.

The method further includes the features described below.

In an alternative embodiment, the scheduling time interval of the traffic type 1 includes n basic time intervals, and the scheduling time interval of the traffic type 2 includes m basic time intervals, where n is greater than or equal to m.

Alternatively, the basic time interval is an appointed duration or number of symbols.

Alternatively, the resource of the traffic type 1 preempted by the traffic type includes: one or more basic time intervals or a part of one basic time interval.

The start position of the traffic type 2 is at any symbol. Alternatively, the traffic type 2 starts at a position that is positive integer multiple of the basic time interval.

Alternatively, the signal for indicating the resource position of the traffic type 2 is any one of the following signals: a cell-specific pilot signal, a UE-specific pilot signal, a broadcast signal, common downlink control information (DCI), and a scrambling sequence.

Alternatively, the base station sends the signal for indicating the resource position of the traffic type 2 includes emitting in any one of the following manners.

The base station sends the signal for indicating the resource position of the traffic type 2 on a designated symbol position in the scheduling time interval of the traffic type 2.

Alternatively, the base station sends the signal for indicating the resource position of the traffic type 2 on a designated symbol after the traffic type 2 occurs; and the symbol position is within the scheduling time interval of the traffic type 1.

Alternatively, the base station sends a predetermined pilot signal within the scheduling time interval of the traffic type 2, and does not send the predetermined pilot signal on the symbol positions configured outside the scheduling time interval of the traffic type 2.

Alternatively, the base station does not send the predetermined pilot signal within the scheduling time interval of the traffic type 2, and sends the predetermined pilot signal on the periodic symbol positions configured outside the scheduling time interval of the traffic type 2. The periodic symbol positions are within the scheduling time interval of the traffic type 1.

Alternatively, the sending position of the signal for indicating the resource position of the traffic type 2 in the scheduling time interval of the traffic type 1 has an appointed relative relationship with the scheduling time interval of the traffic type 2.

Alternatively, the appointed relative relationship includes that the sending position of the signal for indicating the resource position of the traffic type 2 is on a pth symbol after the scheduling time interval of the traffic type 2 or on a qth basic time interval after the traffic type 2.

Alternatively, the method further includes the following steps.

The base station encodes data of the traffic type 1 in segments, and a unit of the segment is the scheduling time interval of the traffic type 2.

The base station selects different scrambling sequences according to whether to schedule the traffic type 2 on the resources of the traffic type 1, and the scrambling sequences are appointed different sequences, which comprises: a scrambling sequence adopted by data of the traffic type 1 sent after the traffic type 2 in the case where the traffic type 2 preempts the resources of the traffic type 1 is different from a scrambling sequence in the case where the traffic type 2 does not preempt the resources of the traffic type 1.

Alternatively, the method further includes the following step.

The base station does not send data of the traffic type 1 on the resource position where the traffic type 2 is scheduled, and proceeds the transmission of the data of the traffic type 1, which was not sent in the scheduling time interval, on a resource position after the scheduling time interval of the traffic type 2.

Alternatively, a modulation and coding scheme (MCS) used by the base station in sending the data of the traffic type 1 at a position after the resource position where the traffic type 2 is scheduled is increased by a pre-appointed MCS incremental value than a MCS used in sending the data of the traffic type 1 at a position before the resource position where the traffic type 2 is scheduled, and/or, frequency resources allocated in sending the data of the traffic type 1 at a position after the resource position where the traffic type 2 is scheduled is increased by a pre-appointed resource amount than frequency resources allocated in sending the data of the traffic type 1 at a position before the resource position where the traffic type 2 is scheduled.

Alternatively, the method further includes the following step.

The base station sends control information of the traffic type 1 after the resource position where the traffic type 2 is scheduled.

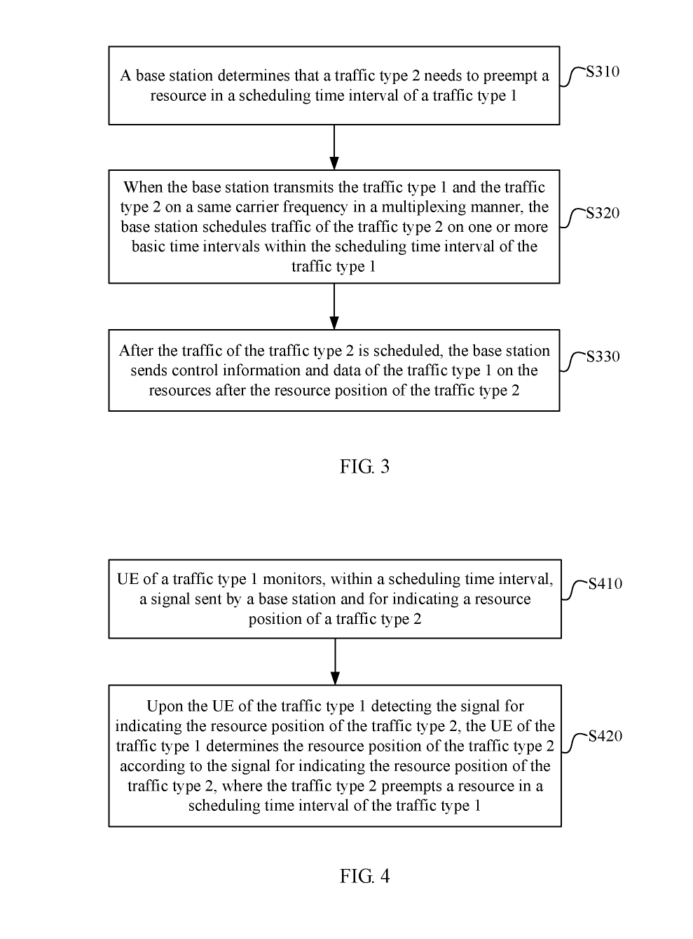

As shown in FIG. 3, an embodiment of the present disclosure provides a data transmission method. The method includes the steps described below.

In step S310, a base station determines that a traffic type 2 needs to preempt resources in a scheduling time interval of a traffic type 1.

In step S320, when the base station transmits the traffic type 1 and the traffic type 2 on a same carrier frequency in the multiplexing manner, the base station schedules traffic of the traffic type 2 on one or more basic time intervals within the scheduling time interval of the traffic type 1.

In step S330, after the traffic of the traffic type 2 is scheduled, the base station sends the control information and data of the traffic type 1 on the resources after the resource position of the traffic type 2.

The method may further include the features described below.

Alternatively, the base station schedules the traffic of the traffic type 2 on one or more basic time intervals within the scheduling time interval of the traffic type 1 in the following manner.

The base station sends control information and/or data of the traffic type 2 on a first basic time interval of the scheduling time interval of the traffic type 1.

Alternatively, the base station sends the control information and data of the traffic type 1 on the resources after the resource position of the traffic type 2 in the following manner.

The base station sends the control information and data of the traffic type 1 on available resources after the control information of the traffic type 2.

Alternatively, the scheduling time interval of the traffic type 1 is scheduled by the base station to start from the available resource after the traffic type 2, and a length of the scheduling time interval of the traffic type 1 is not changed by preempting of the traffic type 2.

Alternatively, the scheduling time interval of the traffic type 1 is scheduled by the base station to start from the available resource after the traffic type 2, and a length of the scheduling time interval of the traffic type 1 is not changed by preempting of the traffic type 2, which includes the followings.

The scheduling time interval of the traffic type 1 is scheduled by the base station to be extended backward by a period of time, the extension time is preempted by the control information of the traffic type 2.

Alternatively, the process that the base station sends the control information and the data of the traffic type 1 on the resources after the resource position of the traffic type 2 is as follows.

The base station sends the control information and the data of the traffic type 1 on remaining resources within the scheduling time interval of the traffic type 1.

Alternatively, a modulation and coding scheme (MCS) used by the base station in sending the control information and data of the traffic type 1 at a position after sending the control information of the traffic type 2 is increased by a pre-appointed MCS incremental value than a MCS used in sending the control information and data of the traffic type 1 in a previous scheduling time interval, and/or allocated frequency resources in sending the control information and data of the traffic type 1 at a position after sending the control information of the traffic type 2 is increased by a pre-appointed resource amount than frequency resources allocated for the traffic type 1 in the previous scheduling time interval.

Alternatively, when the base station transmits the traffic type 1 and the traffic type 2 on the same carrier frequency in the multiplexing manner, the method further includes the following step.

The base station sends a signal for indicating the resource position of the traffic type 2, where the signal is any one of the following signals: a cell-specific pilot signal, a UE-specific pilot signal, a broadcast signal, common downlink control information (DCI), and a scrambling sequence.

As shown in FIG. 4, an embodiment of the present disclosure provides a data transmission method. The method includes the steps described below.

In step S410, a UE of a traffic type 1 monitors, in a scheduling time interval, a signal that indicates a resource position of a traffic type 2, where the signal is sent by a base station.

In step S420, in response to detecting the signal that indicates the resource position of the traffic type 2, the UE of the traffic type 1 determines the resource position of the traffic type 2 according to the signal that indicates the resource position of the traffic type 2.

The traffic type 2 preempts resources in the scheduling time interval of the traffic type 1.

The method further includes the features described below.

Alternatively, the signal indicating the resource position of the traffic type 2 is any one of the following signals: a cell-specific pilot signal, a UE-specific pilot signal, a broadcast signal, common downlink control information (DCI), and a scrambling sequence.

Alternatively, the UE of the traffic type 1 monitors, in the scheduling time interval, the common DCI indicating the resource position of the traffic type 2 sent by the base station, and determines the resource position of the traffic type 2 according to the common DCI for indicating the resource position of the traffic type 2, this process may be as follows.

The UE of the traffic type 1 performs blind detection for the common DCI of a designated position according to an appointed period or symbol by symbol.

In response to successfully detecting the common DCI by the blind detection, the user equipment of the traffic type 1 acquires the resource position of the traffic type 2 according to the common DCI.

Alternatively, the UE of the traffic type 1 monitors, in the scheduling time interval, a broadcast signal indicating the resource position of the traffic type 2 sent by the base station, and determines the resource position of the traffic type 2 according to the broadcast signal indicating the resource position of the traffic type 2, this process may be as follows.

The UE of the traffic type 1 receives the broadcast signal at a designated position according to a period appointed with the base station, or merely receives the broadcast signal at the designated position. The user equipment of the traffic type 1 decodes the received broadcast signal, and acquires the resource position of the traffic type 2 according to the decoding result.

Alternatively, the UE of the traffic type 1 monitors, in the scheduling time interval, the pilot signal indicating the resource position of the traffic type 2 sent by the base station, and determines the resource position of the traffic type 2 according to the pilot signal indicating the resource position of the traffic type 2, this process may be as follows.

The UE of the traffic type 1 monitors the pilot signal at a designated position according to a period appointed with the base station or symbol by symbol. When the UE successfully detects the pilot signal, the user equipment of the traffic type 1 acquires the resource position of the traffic type 2 according to the pilot signal.

Alternatively, the UE of the traffic type 1 monitors the pilot signal according to a period appointed with the base station or symbol by symbol. If the pilot signal is not detected at an appointed symbol position, the UE determines that the resource position of the traffic type 2 is on a position corresponding to the appointed symbol position.

Alternatively, the UE of the traffic type 1 monitors in the scheduling time interval a scrambling sequence indicating the resource position of the traffic type 2, where the scrambling sequence is sent by the base station, and determines the resource position of the traffic type 2 according to the scrambling sequence indicating the resource position of the traffic type 2, this process may be as follows.

When the user equipment of the traffic type 1 decodes received data, if the user equipment fails to descramble data of a present code segment by using a scrambling sequence corresponding to the present code segment and successfully descrambles the data of the present code segment by using another appointed scrambling sequence, it is determined that the traffic type 2 preempts resources of a previous code segment.

Alternatively, after the UE of the traffic type 1 acquires the resource position of the traffic type 2, the method further includes the following steps.

After acquiring the resource position of the traffic type 2, the user equipment of the traffic type 1 discards data at the resource position of the traffic type 2 without decoding. When receiving a hybrid automatic repeat request (HARQ) of the scheduling time interval for retransmitting the data, the user equipment of the traffic type 1 does not merge the data at the resource position of the traffic type 2.

As shown in FIG. 5, an embodiment of the present disclosure provides a data transmission method. The method includes the steps described below.

In step S510, a UE of a traffic type 1 monitors, on one or more basic time intervals in a scheduling time interval, a signal for indicating a resource position of a traffic type 2.

In step S520, upon the UE of the traffic type 1 detecting position information of the traffic type 2, the UE of the traffic type 1 monitors control information of the traffic type 1 on positions after the traffic type 2.

The traffic type 2 preempts resources in the scheduling time interval of the traffic type 1.

The method further includes the features described below.

Alternatively, the step in which the UE of the traffic type 1 monitors the signal for indicating the resource position of the traffic type 2 within the scheduling time interval includes the following step.

According to the period appointed with the base station or symbol by symbol, the UE performs blind detection for a pilot signal indicating the resource position of the traffic type 2, or receives a broadcast signal of a designated position, or performs blind detection for common DCI of the designated position, or decodes a scrambling sequence.

Alternatively, after the UE of the traffic type 1 acquires the control information of the traffic type 1 on the position after the traffic type 2 by blind detection, the method further includes the following steps.

The UE of the traffic type 1 demodulates data according to the control information of the traffic type 1 acquired by blind detection. Optionally, when the resource preempted by the traffic type 2 is in units of basic time intervals, the UE of the traffic type 1 monitors the control information of the traffic type 1 with using the basic time interval as granularity.

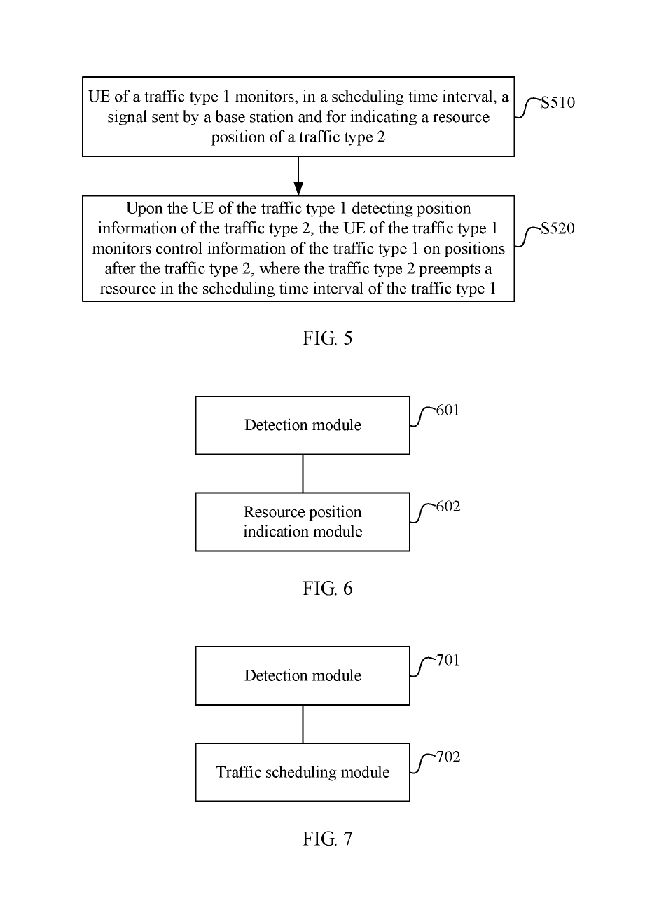

As shown in FIG. 6, an embodiment of the present disclosure provides a data transmission apparatus, applied in a base station. The apparatus includes: a detection module 601 and a resource position indication module 602.

The detection module 601 is configured to determine that a traffic type 2 needs to preempt a resource in a scheduling time interval of a traffic type 1.

The resource position indication module 602 is configured to, when the traffic type 1 and the traffic type 2 are transmitted on a same carrier frequency in a multiplexing manner, send a signal for indicating a resource position of the traffic type 2.

The apparatus further includes the features described below.

Alternatively, the scheduling time interval of the traffic type 1 includes n basic time intervals, and the scheduling time interval of the traffic type 2 includes m basic time intervals; and n is greater than or equal to m.

Alternatively, the signal for indicating the resource position of the traffic type 2 is any one of the following signals: a cell-specific pilot signal, a UE-specific pilot signal, a broadcast signal, common downlink control information (DCI), and a scrambling sequence.

Alternatively, the resource position indication module 602 is configured to send the signal for indicating the resource position of the traffic type 2 in any one of the following manners.

The resource position indication module sends the signal for indicating the resource position of the traffic type 2 on a designated symbol position in the scheduling time interval of the traffic type 2.

Alternatively, the resource position indication module sends the signal for indicating the resource position of the traffic type 2 on a designated symbol after the traffic type 2, and this symbol position is within the scheduling time interval of the traffic type 1.

Alternatively, the resource position indication module sends a predetermined pilot signal within the scheduling time interval of the traffic type 2, and does not send the predetermined pilot signal on the periodic symbol positions configured outside the scheduling time interval of the traffic type 2.

Alternatively, the resource position indication module does not send the predetermined pilot signal within the scheduling time interval of the traffic type 2, and sends the predetermined pilot signal on the periodic symbol positions configured outside the scheduling time interval of the traffic type 2, where the periodic symbol positions are within the scheduling time interval of the traffic type 1.

Alternatively, the sending position of the signal for indicating the resource position of the traffic type 2 within the scheduling time interval of the traffic type 1 has an appointed relative relationship with the scheduling time interval of the traffic type 2.

The appointed relative relationship includes that the sending position of the signal for indicating the resource position of the traffic type 2 is on a pth symbol after the scheduling time interval of the traffic type 2 or on a qth basic time interval after the traffic type 2

Alternatively, the apparatus further includes: an encoding module 603.

The encoding module 603 is configured to encode data of the traffic type 1 in segments, where a unit of the segment is the scheduling time interval of the traffic type 2; and select different scrambling sequences according to whether to schedule the traffic type 2 on the resources of the traffic type 1, where the scrambling sequences are appointed different sequences, which includes that a scrambling sequence adopted by data of the traffic type 1 sent after the traffic type 2 in the case where the traffic type 2 preempts the resources of the traffic type 1 is different from a scrambling sequence in the case where the traffic type 2 does not preempt the resources of the traffic type 1.

Alternatively, the apparatus further includes: a data sending module 604.

The data sending module 604 is configured to not send data of the traffic type 1 on the resource position where the traffic type 2 is scheduled, and proceed to send data of the traffic type 1 that was not sent within the scheduling time interval on a resource position after the scheduling time interval of the traffic type 2.

Alternatively, a modulation and coding scheme (MCS) used by the base station in sending the data of the traffic type 1 at a position after the resource position where the traffic type 2 is scheduled is increased by a pre-appointed MCS incremental value than a MCS used in sending the data of the traffic type 1 at a position before the resource position where the traffic type 2 is scheduled, and/or, allocated frequency resources in sending the data of the traffic type 1 at a position after the resource position where the traffic type 2 is scheduled is increased by a pre-appointed resource amount than allocated frequency resources in sending the data of the traffic type 1 at a position before the resource position where the traffic type 2 is scheduled.

Alternatively, the apparatus further includes: a control information sending module 605.

The control information sending module 605 is configured to send control information of the traffic type 1 after the resource position where the traffic type 2 is scheduled.

Alternatively, the resources of the traffic type 1 preempted by the traffic type 2 includes: one or more basic time intervals or a part of one basic time interval.

A start position of the traffic type 2 may be at any symbol, or at a positive integer multiple of the basic time interval.

Alternatively, the basic time interval is an appointed duration or number of symbols.

Alternatively, the traffic type 1 is enhanced mobile broadband (eMBB) traffic, and the traffic type 2 is ultra-reliable and low latency communications (URLLC) traffic.

As shown in FIG. 7, an embodiment of the present disclosure provides a data transmission apparatus, applied in a base station. The apparatus includes: a detection module 701 and a traffic scheduling module 702.

The detection module 701 is configured to determine that a traffic type 2 needs to preempt a resource in a scheduling time interval of a traffic type 1.

The traffic scheduling module 702 is configured to, when the traffic type 1 and the traffic type 2 are transmitted on a same carrier frequency in a multiplexing manner, schedule traffic of the traffic type 2 on one or more basic time intervals within the scheduling time interval of the traffic type 1; and, after the traffic of the traffic type 2 is scheduled, send control information and data of the traffic type 1 on resources after a resource position of the traffic type 2.

Alternatively, the traffic scheduling module 702 is configured to schedule the traffic of the traffic type 2 on one or more basic time intervals within the scheduling time interval of the traffic type 1 in the following manner.

The traffic scheduling module sends control information and/or data of the traffic type 2 on a first basic time interval of the scheduling time interval of the traffic type 1.

Alternatively, the traffic scheduling module 702 is configured to send the control information and data of the traffic type 1 on the resources after the resource position of the traffic type 2 in the following manner.

The traffic scheduling module sends the control information and data of the traffic type 1 on available resources after the control information of the traffic type 2.

Alternatively, the scheduling time interval of the traffic type 1 is scheduled by the base station to start from the available resource after the traffic type 2, and a length of the scheduling time interval of the traffic type 1 is not changed by preempting of the traffic type 2.

Alternatively, the scheduling time interval of the traffic type 1 is scheduled by the base station to start from the available resource after the traffic type 2, and the length of the scheduling time interval of the traffic type 1 is not changed by preempting of the traffic type 2, including that:

The scheduling time interval of the traffic type 1 is scheduled by the base station to extend backward by a period of time, and the extension time is preempted by the control information of the traffic type 2.

The traffic scheduling module 702 is configured to send the control information and the data of the traffic type 1 on the resources after the resource position of the traffic type 2 in the following manner.

The traffic scheduling module sends the control information and the data of the traffic type 1 on remaining resources of the scheduling time interval of the traffic type 1.

Alternatively, the MCS used by the base station in sending the control information and data of the traffic type 1 at a position after a position where the control information of the traffic type 2 is sent is increased by a pre-appointed MCS incremental value than the MCS used in sending the control information and data of the traffic type 1 in a previous scheduling time interval, and/or, allocated frequency resources in sending the control information and data of the traffic type 1 at a position after a position where the control information of the traffic type 2 is sent is increased by a pre-appointed resource amount than frequency resources allocated for the traffic type 1 in the previous scheduling time interval.

Alternatively, the apparatus further includes: a resource position signal emitting module 703.

The resource position signal emitting module 703 is configured to, when the traffic type 1 and the traffic type 2 are transmitted on the same carrier frequency in a multiplexing manner, further send the signal for indicating the resource position of the traffic type 2. The signal is any one of the following signals: a cell-specific pilot signal, a UE-specific pilot signal, a broadcast signal, common downlink control information (DCI), and a scrambling sequence.

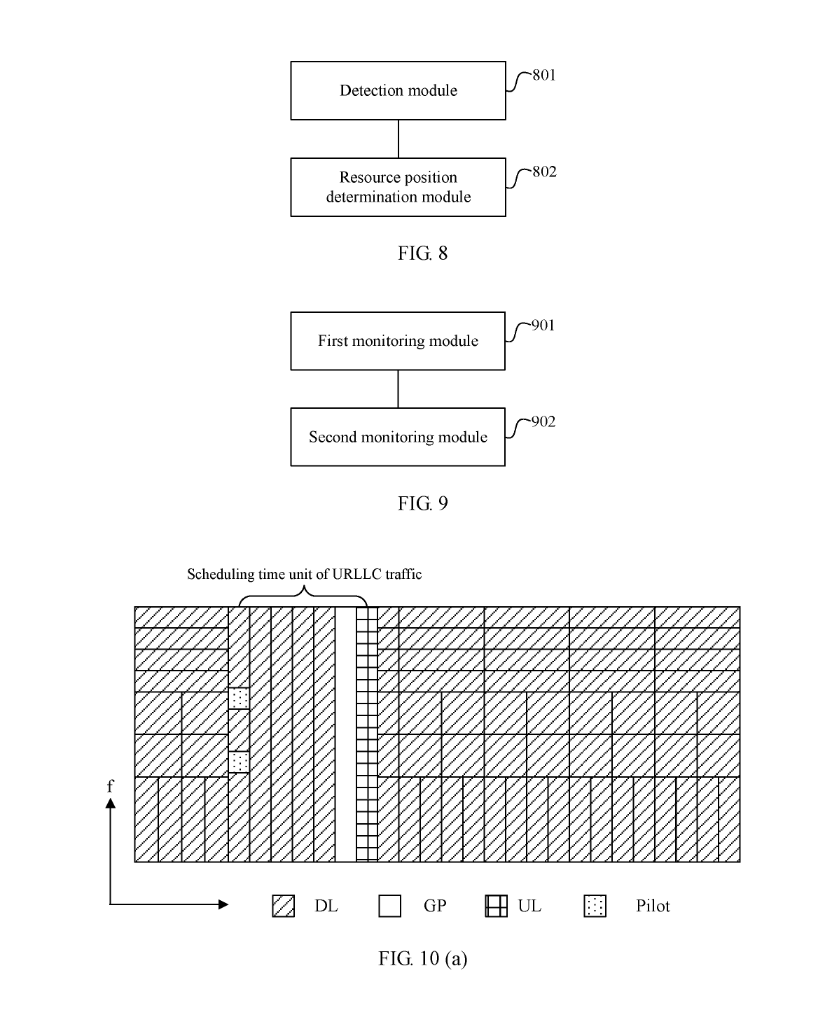

As shown in FIG. 8, an embodiment of the present disclosure provides a data transmission apparatus, applied to UE of a traffic type 1. The apparatus includes: a monitoring module 801 and a resource position determination module 802.

The monitoring module 801 is configured to monitor, in a scheduling time interval, a signal that is sent by a base station and indicates a resource position of a traffic type 2.

The resource position determination module 802 is configured to, in response to detecting the signal indicating the resource position of the traffic type 2, determine the resource position of the traffic type 2 according to the signal indicating the resource position of the traffic type 2.

The traffic type 2 preempts a resource in the scheduling time interval of the traffic type 1.

Alternatively, the signal indicating the resource position of the traffic type 2 is any one of the following signals: a cell-specific pilot signal, a UE-specific pilot signal, a broadcast signal, common downlink control information (DCI), and a scrambling sequence.

Alternatively, the monitoring module 801 is configured to monitor, in the scheduling time interval, the signal sent by the base station and indicating the resource position of the traffic type 2 in the following manner. The UE of the traffic type 1 performs blind detection for the common DCI at a designated position according to an appointed period or symbol by symbol.

After the signal indicating the resource position of the traffic type 2 is detected, the resource position determination module 802 is configured to determine the resource position of the traffic type 2 according to the signal for indicating the resource position of the traffic type 2 in a manner described below. After the UE of the traffic type 1 successfully acquires the common DCI by blind detection, the UE acquires the resource position of the traffic type 2 according to the common DCI.

Alternatively, the monitoring module 801 is configured to monitor, in the scheduling time interval, the signal sent by the base station indicating the resource position of the traffic type 2 in the following manner. The monitoring module receives the broadcast signal at a designated position according to a period appointed with the base station, or only receives the broadcast signal at the designated position.

After the signal indicating the resource position of the traffic type 2 is detected, the resource position determination module 802 is configured to determine the resource position of the traffic type 2 according to the signal indicating the resource position of the traffic type 2 in the following manner. The resource position determination module decodes received broadcast signal, and acquires the resource position of the traffic type 2 according to the decoding result.

Alternatively, the monitoring module 801 is configured to monitor, in the scheduling time interval, the signal that is sent by the base station and indicates the resource position of the traffic type 2 in the following manner. The monitoring module monitors the pilot signal of a designated position according to a period appointed with the base station or symbol by symbol.

After the signal for indicating the resource position of the traffic type 2 is detected, the resource position determination module 802 is configured to determine the resource position of the traffic type 2 according to the signal for indicating the resource position of the traffic type 2 in the following manner. After the pilot signal is detected successfully, the UE acquires the resource position of the traffic type 2 according to the pilot signal.

Alternatively, in the scheduling time interval, the monitoring module 801 is configured to monitor the signal for indicating the resource position of the traffic type 2 sent by the base station in the following manner. The monitoring module monitors the pilot signal according to the period appointed with the base station or symbol by symbol.

After the signal for indicating the resource position of the traffic type 2 is detected, the resource position determination module 802 is configured to determine the resource position of the traffic type 2 according to the signal for indicating the resource position of the traffic type 2 in the following manner. If the pilot signal cannot be detected at an appointed symbol position, the resource position determination module determines that the resource position of the traffic type 2 is at a position corresponding to the appointed symbol position.

Alternatively, after the signal for indicating the resource position of the traffic type 2 is detected, the resource position determination module 802 is configured to determine the resource position of the traffic type 2 according to the signal for indicating the resource position of the traffic type 2 in the following manner. When decoding the received data, in response to failing to descramble data of a present code segment by using a scrambling sequence corresponding to the present code segment and successfully descrambling the data of the present code segment by using another appointed scrambling sequence, it is determined that the traffic type 2 preempts resources of a previous code segment.

Alternatively, the apparatus further includes: a data processing module 803.

The data processing module 803 is configured to, after acquiring the resource position of the traffic type 2, discard data at the resource position of the traffic type 2 without decoding; and in response to receiving a hybrid automatic repeat request (HARQ) of the scheduling time interval for data retransmission, not merge the data at the resource position of the traffic type 2.

As shown in FIG. 9, an embodiment of the present disclosure provides a data transmission apparatus, applied to a UE of a traffic type 1. The apparatus includes: a first monitoring module 901 and a second monitoring module 902.

The first monitoring module 901 is configured to monitor, in a scheduling time interval, a signal for indicating a resource position of a traffic type 2, wherein the signal is sent by a base station.

The second monitoring module 902 is configured to, after position information of the traffic type 2 is detected, monitor control information of the traffic type 1 on positions after the traffic type 2.

The traffic type 2 preempts a resource in the scheduling time interval of the traffic type 1.

Alternatively, the first monitoring module 901 is configured to monitor the signal for indicating the resource position of the traffic type 2 within the scheduling time interval in the following manner.

According to a period appointed with the base station or symbol by symbol, the first monitoring module performs blind detection for the pilot signal for indicating the resource position of the traffic type 2, or receives a broadcast signal at the designated position, or performs blind detection for common DCI at the designated position or decodes a scrambling sequence.

Alternatively, the apparatus further includes a decoding module.

After the control information of the traffic type 1 is acquired at the position after the traffic type 2 by blind detection, the decoding module is configured to demodulate data according to the control information of the traffic type 1 acquired by blind detection.

Alternatively, when the resource preempted by the traffic type 2 is in units of basic time intervals, the UE of the traffic type 1 monitors the control information of the traffic type 1 with using the basic time interval as the granularity.

It is assumed that the scheduling time interval of the URLLC traffic is seven symbols. In resource position indication diagrams of embodiments one to nine described below, a vertical axis f represents frequency, and a horizontal axis t represents time.

### Embodiment One

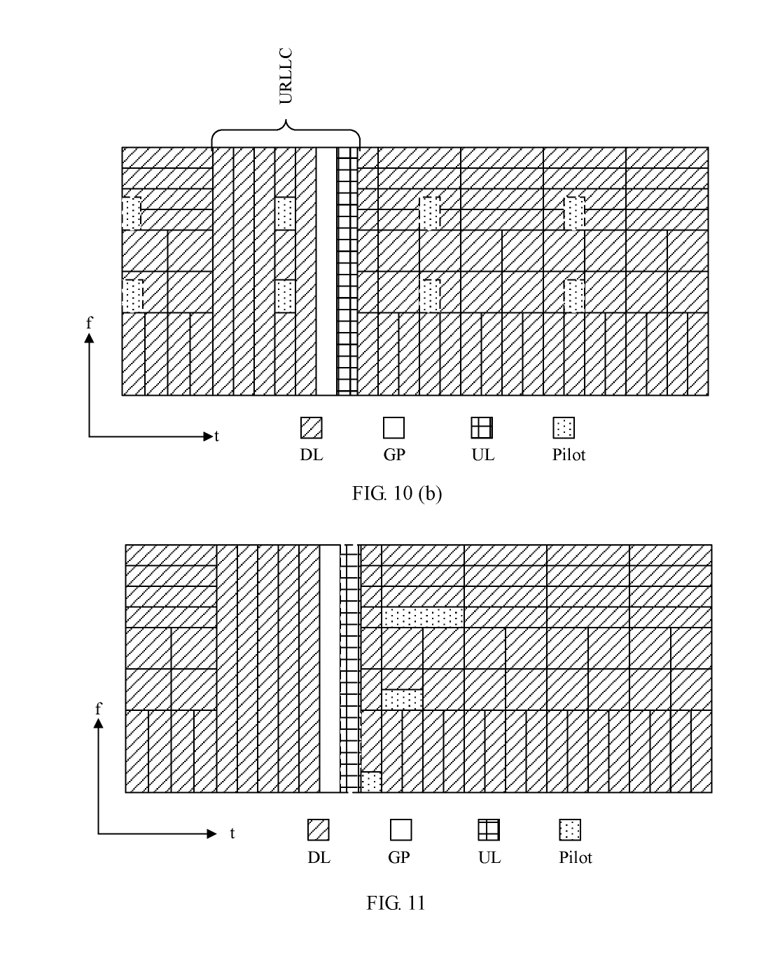

A base station configures a pilot signal. For example, the pilot signal is cell-specific. The base station sends out the pilot signal when the same carrier frequency is multiplexed by the eMBB traffic and the URLLC traffic. For example, the base station may have a convention that the pilot signal is transmitted on a fixed position in a scheduling time interval of the URLLC traffic. As shown in FIG. 10 (a), for example, the pilot signal is sent on a pth (p is a positive integer) OFDM symbol of the scheduling time interval of the URLLC traffic.

The base station may proceed to send data of the eMBB traffic after scheduling URLLC resources. The base station may transmit the rest eMBB data according to control information used in the initial transmission of the eMBB data. Alternatively, the MCS and/or frequency domain resources in the initial transmission of the eMBB data may be increased by an appointed value, and used for transmitting the rest eMBB data. Alternatively, the base station may send new control information.

The UE of the eMBB traffic receives data sent by the bases station and performs blind detection for the pilot signal symbol by symbol. Once the UE successfully detects the pilot signal, the UE can determine a resource position of the URLLC traffic. In the embodiment in which the base station sends the new control information DCI after scheduling the URLLC traffic, the UE of the eMBB traffic also needs to monitor the new DCI.

In the embodiment in which the base station increases the MCS and/or frequency domain resources, which are used in sending the eMBB traffic after sending the URLLC traffic, by the appointed value, the UE of the eMBB traffic demodulates data according to the increased MCS and/or frequency domain resources. If the base station does not increase the MCS and/or frequency domain resources, the UE of the eMBB traffic demodulates the data according to the initial control information.

After the UE of the eMBB traffic acquires the resource position of the URLLC traffic, the UE may discard data at the URLLC traffic without decoding the data at the URLLC traffic. When the UE of the traffic type 1 receives a HARQ of the scheduling time interval for data retransmission, the UE of the traffic type 1 does not merge the data transmitted using the resources preempted by the URLLC traffic.

### Embodiment two

The base station configures a pilot signal. As shown in FIG. 10 (b), the pilot signal has periodic candidate positions. The period of the periodic candidate positions may be a scheduling time interval of a traffic type 2. The candidate positions are represented by the pilot signals with a dotted box in FIG. 10 (b). The base station sends the pilot signal only when the URLLC traffic is transmitted. If the URLLC traffic is allowed to be at any time of the scheduling time interval of the eMBB traffic, the position of the pilot signal in the scheduling time interval of the URLLC traffic is not fixed. The base station may configure pilot signals with different sequences for different positions.

After scheduling the URLLC resources, the base station may proceed to schedule the traffic scheduled before scheduling the URLLC resources. The base station may send the rest eMBB data according to the control information sent before scheduling the URLLC resources. Alternatively, the base station may increase the MCS and/or frequency domain resources by a pre-appointed value. Alternatively, the base station may also send out new control information.

The UE of the eMBB traffic monitors the pilot signal according to the appointed period. If the traffic type 2 is allowed to be at any symbol, the UE needs to blindly detect different pilot sequences. Once the UE detect the pilot signal successfully, the UE can determine the position of the pilot signal in the scheduling time interval of the URLLC traffic, and thus determine the resource position of the URLLC traffic.

If the base station increases the MCS and/or frequency domain resources used for sending the eMBB traffic after the URLLC traffic is sent by the appointed value, the UE of the eMBB traffic demodulates data according to the increased MCS and/or frequency domain resources. If the base station does not increases the MCS and/or frequency domain resources, the UE of the eMBB traffic demodulates data with continuing using the initial control information.

If the base station sends new DCI after scheduling the URLLC traffic, the UE of the eMBB traffic also needs to monitor the new DCI.

After acquiring the resource position of the URLLC traffic, the UE of the eMBB traffic may discard data at the resource position of the URLLC traffic with decoding the data. When the UE of the traffic type 1 receives the HARQ of the scheduling time interval for data retransmission, the UE of the traffic type 1 does not merge the data at the resources preempted by the URLLC traffic.

### Embodiment Three

The base station configures a pilot signal. For example, the pilot signal is UE-specific to the UE of the traffic type 1. The base station sends the pilot signal merely when the eMBB traffic and the URLLC traffic are transmitted on the same carrier frequency in the multiplexing manner. The position of the pilot signal has an appointed relative relationship with the URLLC traffic. For example, the base station sends the pilot signal on the pth available OFDM symbol or the pth basic time interval after the URLLC traffic. p is a positive integer. The value of p may be 1, 2 or other values that the base station considers reasonable. The value of p is appointed in advance, or the UE of the eMBB traffic is notified of the value of p through broadcast signaling.

After the URLLC traffic is sent, the base station may proceed to send the traffic which was sent before sending the URLLC. The base station may send the rest eMBB data according to initially sent control information. Alternatively. The base station may also add an appointed value to MCS and/or frequency domain resources. Alternatively, the base station may send new control information.

After the UE of the eMBB traffic successfully detects the pilot signal, a position of the URLLC traffic is determined.

If the base station increases the MCS and/or frequency domain resources used in sending the eMBB traffic after the URLLC traffic by an appointed value, the UE of the eMBB traffic demodulates data according to the increased MCS and/or frequency domain resources. If the MCS and/or frequency domain resources are not increased, the UE of the eMBB traffic demodulates data according to the initial control information.

If the base station sends new control information after sending the URLLC traffic, the UE of the eMBB traffic also attempts to blindly detect DCI after the URLLC traffic. If the DCI is detected successfully, the data is demodulated according to the detected DCI. If the base station does not send new DCI, the UE of the eMBB traffic demodulates data according to the DCI detected before.

After acquiring the resource position of the URLLC traffic, the UE of the eMBB traffic may discard data at the resource position of the URLLC without decoding. When the UE of the traffic type 1 receives a HARQ of the scheduling time interval for data retransmission, the UE of the traffic type 1 does not merge the data at resources preempted by the URLLC traffic.

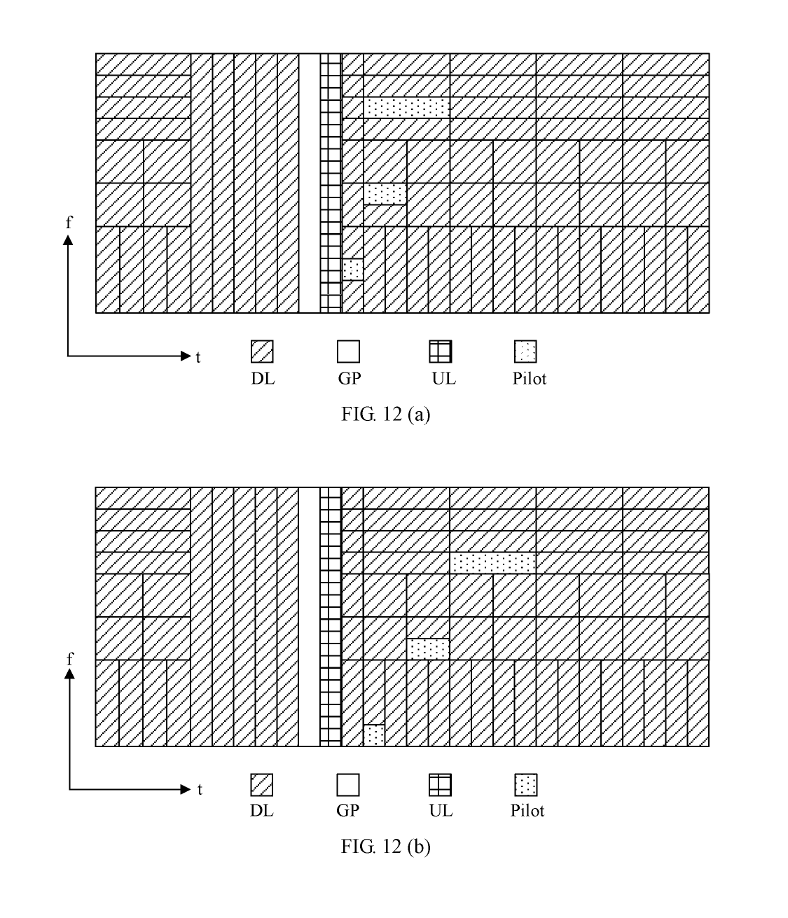

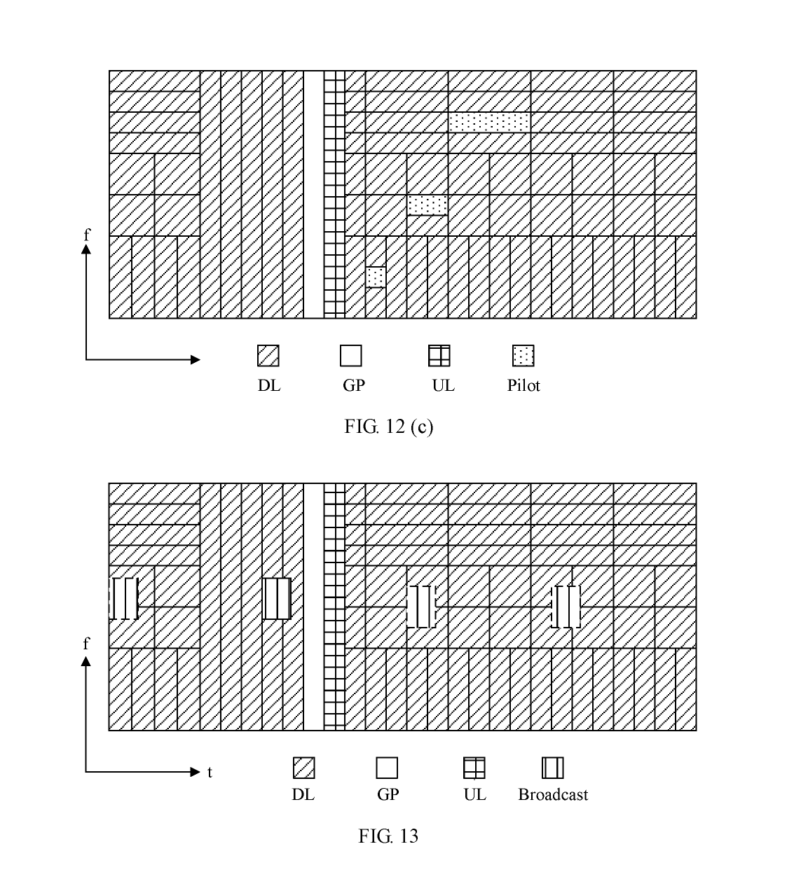

In scenarios shown in FIG. 11 where different numerologies are multiplexed, if the UE has the capability of supporting multiple numerologies, the pilot signal may be sent adjacent to the URLLC traffic. As shown in FIGS. 12 (a) to (c), the frequency position of the pilot signal includes, but is not limited to, the position shown in the figures. The frequency position of the pilot signal may be any appointed frequency position on numerology resources corresponding to any appointed available symbols.

### Embodiment Four

As shown in FIG. 13, the base station configures a broadcast signal. The base station sends the broadcast signal only when the eMBB traffic and the URLLC traffic are transmitted on the same carrier frequency in a multiplexing manner. Possible positions of the broadcast signal configured by the base station have fixed intervals on the time domain. The time interval may be the scheduling time interval of the URLLC traffic. The possible positions are represented by the broadcast signals with a dotted box in FIG. 13. The numerology and frequency domain position of the broadcast signal may be the same with the synchronization signal or broadcast signal on the possible position (which is specifically determined according to a final protocol). The base station does not need to send resource position information of the URLLC traffic in DCI of the URLLC traffic. After the URLLC resources, the base station may proceed to send the traffic interrupted by the URLLC. The base station may send the rest eMBB data according to initially sent control information, or may add an appointed value to MCS and/or frequency domain resources. Alternatively, the base station may send new control information.

The UE of the URLLC traffic and UE of the eMBB traffic both monitor the broadcast signal according to a pre-appointed period. Once the UE of the URLLC traffic successfully acquires the broadcast signal by blind detection, the UE of the URLLC traffic detects the traffic data at a position indicated by the broadcast signal. After the UE of the eMBB traffic successfully acquires the broadcast signal by blind detection, the position of the URLLC resources can be determined. If the base station sends new DCI information after sending the URLLC resources, the UE of the eMBB traffic attempts to blindly detect the DCI at positions after the URLLC resources. If the DCI is detected successfully, the UE of the eMBB traffic demodulates the data according to the DCI. If the base station does not send the new DCI, the UE of the eMBB traffic proceeds to demodulate the data according to the DCI detected before. If the MCS and/or frequency domain resources used by the base station in transmitting the eMBB traffic after the URLLC traffic is increased by an appointed value, the UE of the eMBB traffic demodulates the data according to the MCS and/or frequency domain resources.

After acquiring the resource position of the URLLC traffic, the UE of the eMBB traffic may discard data at the resource position of the URLLC traffic without decoding. After the UE of the traffic type 1 receives the HARQ of the scheduling time interval for data retransmission, the UE of the traffic type 1 does not merge the data at the resources preempted by the URLLC traffic.

### Embodiment Five

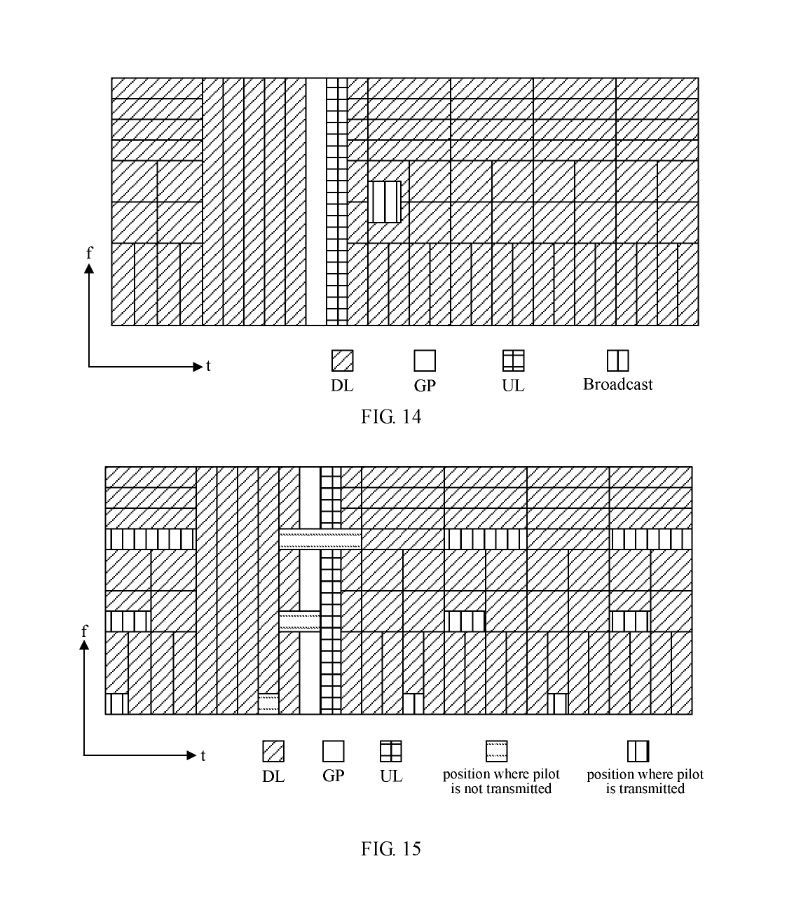

As shown in FIG. 14, on the basis of embodiments three and four, the base station configures a broadcast signal. The base station sends the broadcast signal when the eMBB traffic and URLLC traffic are transmitted on the same carrier frequency in a multiplexing manner, and the position of the broadcast signal is an appointed position after the URLLC traffic in the time domain, for example, the position of the broadcast signal is the pth symbol after the URLLC traffic. The numerology and frequency domain position adopted by the broadcast signal may be the same with that of the synchronization signal or broadcast signal on the possible position (which is specifically determined according to a final protocol). The base station does not need to send resource position information of the URLLC in the DCI of the URLLC traffic. The base station may proceed to send previous traffic at positions after URLLC resources. The base station may send the rest eMBB data according to initially sent control information. Alternatively, the base station may increase the MCS and/or frequency domain resource by an appointed value. Alternatively, the base station may also send new control information.

The UE of the URLLC traffic and UE of the eMBB traffic may perform blind detection for the broadcast signal symbol by symbol. Upon the UE of the URLLC traffic successfully detecting the broadcast signal by the blind detection, the UE of the URLLC traffic can detect its traffic data at a position indicated by the broadcast signal. After the UE of the eMBB traffic successfully acquires the broadcast signal by the blind detection, the UE of the eMBB traffic can determine the position of the URLLC resource according to an appointed relative relationship between the broadcast signal and the URLLC resource. If the base station sends new control information at a positon after the URLLC traffic, the UE of the eMBB traffic also attempts to blindly detects the new DCI at positions after the URLLC traffic. If the UE of the eMBB traffic acquires the DCI successfully, the UE of the eMBB traffic demodulates data according to the DCI. If the base station does not send the new DCI, the UE of the eMBB traffic demodulates data still according to the DCI detected before. If the base station increases the MCS and/or frequency domain resource used for sending the eMBB traffic after the URLLC traffic by an appointed value, the UE of the eMBB traffic demodulates data according to the MCS and/or frequency domain resource.

After acquiring the resource position of the URLLC traffic, the UE of the eMBB traffic may discard data at the resource position of the URLLC traffic without decoding. After the UE of the traffic type 1 receives the HARQ of the scheduling time interval for data retransmission, the UE of the traffic type 1 does not merge the data at the resources preempted by the URLLC traffic.

### Embodiment Six

As shown in FIG. 15, the base station configures a pilot signal for the UE of the eMBB traffic, where the pilot signal is periodically sent. For example, the pilot signal is UE-specific to the UE of the traffic type 1. The period may be a scheduling time interval of the URLLC traffic. The base station does not send the pilot signal when scheduling the URLLC traffic. The base station may send new control information after the URLLC resource. The base station may sends the rest eMBB data according to initially transmitted control information. Alternatively, the base station may increase the MCS and/or frequency domain resource by an appointed value. The base station may proceed to send previous traffic.

The UE of the eMBB traffic blindly detects the pilot signal based on the fixed period. If the UE of the eMBB traffic does not detect the pilot signal by blind detection, the UE of the eMBB traffic determines that the resource of the scheduling time interval of the eMBB traffic is multiplexed by the URLLC traffic.

After the UE of the eMBB traffic learns the existence of the URLLC traffic, if it is appointed that the base station sends the new control information after the URLLC resource, the UE of the eMBB traffic attempts to blindly detect the DCI after URLLC traffic resource. If the DCI is detected successfully, the UE of the eMBB traffic demodulates data according to the DCI. If the DCI is not detected, then the traffic for the UE of the eMBB traffic is not scheduled on these resources. If the base station does not send the new DCI, the UE of the eMBB traffic proceeds to demodulate data according to the DCI detected before. If the base station increases the MCS and/or frequency domain resource used for transmitting the eMBB traffic after the URLLC traffic by an appointed value, the UE of the eMBB traffic demodulates data according to the MCS and/or frequency domain resource.

After learning the resource position of the URLLC traffic, the UE of the eMBB traffic may discard data at the resource position without decoding. After the UE of the traffic type 1 receives the HARQ of the scheduling time interval for data retransmission, the UE of the traffic type 1 does not merge the data at resources preempted by the URLLC traffic.

### Embodiment Seven

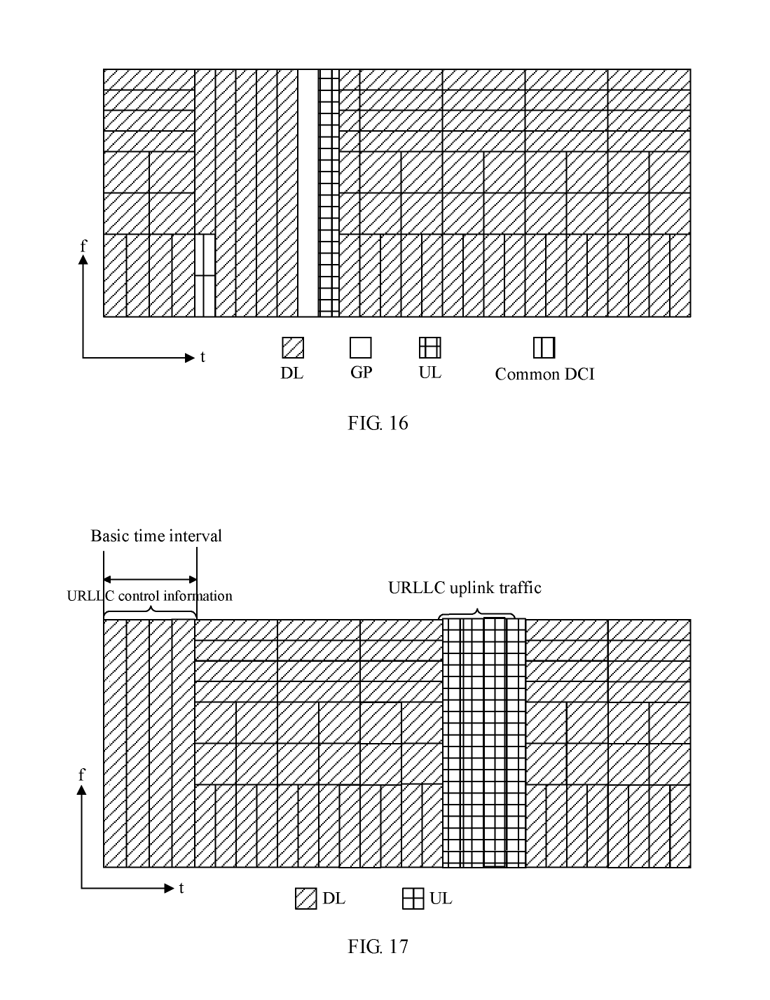

As shown in FIG. 16, the base station configures two types of DCI for the URLLC traffic. One type of DCI only includes position information of the URLLC traffic. This DCI is common, and can be detected by UEs of all traffic types (this DCI is scrambled by a common radio network temporary identifier (RNTI), and the common RNTI may be appointed in advance, or the UE may be notified of this common RNTI through common control signaling). The other type of DCI is UE-specific, and can only be detected by the UE of the scheduled URLLC traffic (this DCI is scrambled by a cell radio network temporary identifier (C-RNTI)). The base station may send new control information after the URLLC resource. The base station may send the rest eMBB data according to initially sent control information. Alternatively, the base station may increase the MCS and/or frequency domain resource by an appointed value. Alternatively, the base station may proceed to transmit the previous traffic.

The UE of the URLLC traffic needs to blindly detect the common DCI and the UE-specific DCI, and demodulates the URLLC traffic by combining the two types of information.

After successfully acquiring the common DCI by blind detection, the UE of the eMBB traffic can determine the position of the URLLC resource. If it is appointed that the base station sends the new control information after the URLLC resource, the UE of the eMBB traffic attempts to blindly detect the DCI at positions after URLLC traffic resource. If the DCI is detected successfully, the UE of the eMBB traffic demodulates data according to the detected DCI. If the DCI is not detected, it is determined that the traffic for the UE is not scheduled on these resources. If the base station does not send new DCI, the UE of the eMBB traffic proceeds to demodulate data according to the DCI detected before. If the base station increase the MCS and/or frequency domain resource used for sending the eMBB traffic after the URLLC traffic by an appointed value, the UE of the eMBB traffic demodulates data according to the MCS and/or frequency domain resource.

After learning the resource position of the URLLC traffic, the UE of the eMBB traffic may discard data at the resource position without decoding. After the UE of the traffic type 1 receives the HARQ of the scheduling time interval for data retransmission, the UE of the traffic type 1 does not merge the data at the resources preempted by the URLLC traffic.

### Embodiment Eight

The base station can only schedule the URLLC traffic at a specific position. The base station schedules the URLLC traffic at the time position which is an integer multiple of the scheduling time interval of the URLLC traffic. The base station encodes data of the eMBB traffic in segments, and the used scrambling sequences may be different. For example, the base station scrambles the data of the eMBB traffic by using a scrambling sequence C0 before the URLLC traffic is scheduled, and scrambles the data of the eMBB traffic by using a scrambling sequence C1 after the URLLC traffic is scheduled.

After receiving data, the UE of the eMBB traffic descrambles and decodes the data according to the scrambling sequence C0. If the data cannot be decoded correctly, the UE of the eMBB traffic attempts to descramble the data with the scrambling sequence C1. Once the UE of the eMBB traffic decodes the data correctly by using the scrambling sequence C1, it is determined that the URLLC traffic is scheduled on the code segment previous to the present code segment.

After learning the resource position of the URLLC traffic, the UE of the eMBB traffic may discard data at the resource position without decoding. After the UE of the traffic type 1 receives the HARQ of the scheduling time interval for data retransmission, the UE of the traffic type 1 does not merge the data at the resources preempted by the URLLC traffic.

### Embodiment Nine

As shown in FIG. 17, the base station sends control information and/or data of the of URLLC traffic (the control information may be A (Acknowledge)/N (negative acknowledge) or may be UL grant and/or DCI) at a start position of a scheduling time interval of the eMBB traffic. Resources preempted by the control information of the URLLC traffic may be one or more OFDM symbols, one slot (such as half basic time interval) or one or more basic time intervals. Optionally, the base station sends a signal (the may be any one of signals in the above embodiments one to seven) after sending the control information of the URLLC traffic. Optionally, the base station sends control information and corresponding traffic data of eMBB traffic after sending the control information of the URLLC traffic. The base station may schedule the eMBB traffic without changing the scheduling time interval of the eMBB traffic, and may also only schedule the eMBB traffic on the remaining resources.

The basic time interval preempted by the control information of the URLLC traffic is denoted by n. The UE of the URLLC traffic obtains the uplink grant information, and then sends a physical uplink shared channel (PUSCH)/a physical uplink control channel (PUCCH) on the n+k basic time interval according to the control indication. k is a positive integer and is appointed by the base station. Preferably, the uplink resource of the URLLC traffic may be multiplexed with the eMBB traffic on the same resource. In FIG. 17, the URLLC traffic preempts one basic time interval and k equals to 3.

After the UE of the eMBB traffic detects a resource position of the URLLC traffic according to the signal sent by the base station, the UE of the eMBB traffic may perform blind detection for the DCI. If the base station does not send the signal for indicating the resource position of the URLLC traffic, the UE of the eMBB periodically monitors the control information according to the basic time interval, or monitors the control information symbol by symbol, or monitors the control information slot by slot. The UE of the eMBB demodulates data according to the successfully detected DCI, and the URLLC traffic is located on an appointed position of the n+k basic time interval.

After learning the resource position of the URLLC traffic, the UE of the eMBB traffic may discard data at the resource position of the URLLC traffic without decoding. After the UE of the traffic type 1 receives the HARQ of the scheduling time interval for data retransmission, the UE of the traffic type 1 does not merge the data at the resource preempted by the URLLC traffic.

The above embodiments of the present disclosure provides a data transmission method and a data transmission apparatus. When the traffic type 2 preempts part of resources of the traffic type 1, the base station sends a signal for indicating a resource position of the traffic type 2, the UE of the traffic type 1 acquires resource position information of the traffic type 2, thereby ensuring the correct decoding, retransmission and merging in the traffic reception. Alternatively, when the traffic type 2 preempts the resources of the traffic type 1, the base station proceeds to transmit control information and data of the traffic type 1 after scheduling traffic of the traffic type 2, thereby ensuring that the UE of the traffic type 1 receives the traffic correctly.

It should be understood by those skilled in the art that functional modules/units in all or part of the steps of the method, the system and the apparatus disclosed above may be implemented as software, firmware, hardware and appropriate combinations thereof. In the hardware implementation, the division of the functional modules/units mentioned in the above description may not correspond to the division of physical components. For example, one physical component may have several functions, or one function or step may be implemented jointly by several physical components. Some or all components may be implemented as software executed by processors such as digital signal processors or microcontrollers, hardware, or integrated circuits such as application specific integrated circuits. Such software may be distributed on a computer-readable medium, which may include a computer storage medium (or a non-transitory medium) and a communication medium (or a transitory medium).

As is known to those skilled in the art, the term “computer storage medium” includes volatile or nonvolatile, removable or non-removable medium implemented in any method or technology for storing information (such as computer-readable instructions, data structures, program modules or other data). The computer storage medium includes, but is not limited to, a random access memory (RAM), a read-only memory (ROM), an electrically erasable programmable read-only memory (EEPROM), a flash memory or other memory technologies, a compact disc-read only memory (CD-ROM), a digital versatile disc (DVD) or other optical disc storage, a magnetic cassette, a magnetic tape, a magnetic disk storage or other magnetic storage apparatuses, or any other medium used for storing desired information and accessible by a computer. In addition, as is known to those skilled in the art, the communication medium generally includes computer-readable instructions, data structures, program modules or other data in modulated data signals such as carriers or other transmission mechanisms, and may include any information delivery medium.

It should be noted that the present application may have other various embodiments. Corresponding changes and modifications may be made by those skilled in the art according to the present application without departing from the spirit and essence of the present application. However, these corresponding changes and modifications fall within the scope of the claims in the present application.

### INDUSTRIAL APPLICABILITY

According to technical solutions provided by embodiments of the present disclosure, when a traffic type 2 preempts part of resources of a traffic type 1, a base station sends a signal for indicating a resource position of the traffic type 2, the UE of the traffic type 1 acquires resource position information of the traffic type 2, thereby ensuring the correct decoding, retransmission and merging om the traffic reception. Alternatively, when the traffic type 2 preempts the resources of the traffic type 1, the base station proceeds to send control information and data of the traffic type 1 after scheduling traffic of the traffic type 2, thereby ensuring that the UE of the traffic type 1 receives the traffic correctly.

1. A data transmission method, comprising:
determining, by a base station, that a traffic type 2 needs to preempt a resource in a scheduling time interval of a traffic type 1; and
when transmitting the traffic type 1 and the traffic type 2 on a same carrier frequency in a multiplexing manner, sending, by the base station, a signal to a user equipment, wherein the signal indicates that a resource in the scheduling time interval of a traffic type 1 is preempted by the traffic type 2.

2. The method of claim 1, wherein the scheduling time interval of the traffic type 1 comprises n basic time intervals, and a scheduling time interval of the traffic type 2 comprises m basic time intervals; and n is greater than or equal to m.

3. The method of claim 1, wherein the signal is one of the following signals: a cell-specific pilot signal, a user-equipment-specific pilot signal, a broadcast signal, common downlink control information (DCI), and a scrambling sequence.

4. The method of claim 2, wherein the base station sends the signal in one of the following manners:
sending, by the base station, the signal on a designated symbol position in the scheduling time interval of the traffic type 2;
sending, by the base station, the signal on a designated symbol after the scheduling time interval of the traffic type 2; and the designated symbol position is within the scheduling time interval of the traffic type 1;
sending, by the base station, a predetermined pilot signal within the scheduling time interval of the traffic type 2, and not sending, by the base station, the predetermined pilot signal on periodic symbol positions configured outside the scheduling time interval of the traffic type 2; or
not sending, by the base station, the predetermined pilot signal within the scheduling time interval of the traffic type 2, and sending, by the base station, the predetermined pilot signal on the periodic symbol positions configured outside the scheduling time interval of the traffic type 2; wherein the periodic symbol positions are within the scheduling time interval of the traffic type 1.

5. The method of claim 4, wherein a sending position of the signal is within the scheduling time interval of the traffic type 1 and has an appointed relative relationship with the scheduling time interval of the traffic type 2;
wherein the appointed relative relationship comprises that: the sending position of the signal is on a pth symbol after the scheduling time interval of the traffic type 2 or on a qth basic time interval after the traffic type 2.

6. (canceled)

7. The method of claim 1, further comprising: not sending data of the traffic type 1 on a resource position where the traffic type 2 is scheduled by the base station, and sending remaining data of the traffic type 1 on a resource position after the scheduling time interval of the traffic type 2.

8. (canceled)

9. (canceled)

10. The method of claim 2, wherein the resource of the traffic type 1 preempted by the traffic type 2 comprises: one or more basic time intervals or a part of one basic time interval;
wherein a start position of the traffic type 2 is at any symbol, or a positive integer multiple of the basic time interval.

11. The method of claim 2, wherein the basic time interval is an appointed duration or an appointed number of symbols.

12. The method of claim 1, wherein the traffic type 1 is enhanced mobile broadband (eMBB) traffic, and the traffic type 2 is ultra-reliable and low latency communications (URLLC) traffic.

13-20. (canceled)

21. A data transmission method, comprising:
monitoring, by a user equipment of a traffic type 1, a signal by a base station within a scheduling time interval, wherein the signal indicates that a resource of the traffic type 1 is preempted by a traffic type 2; and
in response to detecting the signal determining, by the user equipment of the traffic type 1, a resource position of the traffic type 2 according to the signal.

22. The method of claim 21, wherein the signal is one of the following signals: a cell-specific pilot signal, a user-equipment-specific pilot signal, a broadcast signal, common downlink control information (DCI), and a scrambling sequence.

23. The method of claim 22, wherein monitoring, by the user equipment of the traffic type 1, the common DCI sent by the base station in the scheduling time interval, and determining the resource position of the traffic type 2 according to the common DCI comprises:
performing blind detection, by the user equipment of the traffic type 1, for the common DCI at a designated position according to an appointed period or symbol by symbol; and
in response to successfully detecting the common DCI by the blind detection, acquiring, by the user equipment of the traffic type 1, the resource position of the traffic type 2 according to the common DCI.

24-26. (canceled)

27. The method of claim 21, wherein after the user equipment of the traffic type 1 acquires the resource position of the traffic type 2, the method further comprises:
discarding, by the user equipment of the traffic type 1, data at the resource position of the traffic type 2 without decoding; and in response to receiving a hybrid automatic repeat request (HARD) of the scheduling time interval for retransmitting the data, not merging, by the user equipment of the traffic type 1, the data at the resource position of the traffic type 2.

28-41. (canceled)

42. A base station, comprising:
a processor; and
a memory communicably connected to the processor for storing instructions executable by the processor,
wherein the base station is configured to transmit first type traffic and second type traffic on a same carrier frequency in a multiplexing manner, wherein the first type traffic is transmitted to a first user equipment and the second type traffic is transmitted to a second user equipment,
wherein the base station is configured to:
determine that the second type traffic preempts a resource of a scheduling time interval of the first type traffic;
send an indication signal to the first user equipment, wherein the indication signal indicates that the second type traffic preempts a resource of the scheduling time interval of the first type traffic.

43. The base station according to claim 42, wherein the indication signal is one of: a cell-specific pilot signal, a user-equipment-specific pilot signal, a broadcast signal, common downlink control information (DCI), and a scrambling sequence.

44. The base station according to claim 42, wherein the base station is configured to send the indication signal in one of the following manners:
sending the indication signal on a designated symbol position in a scheduling time interval of the second type traffic;
sending the indication signal on a designated symbol after the second type traffic occurs, wherein the designated symbol position is within the scheduling time interval of the first type traffic;
sending a predetermined pilot signal within the scheduling time interval of the second type traffic, and not sending the predetermined pilot signal on periodic symbol positions configured outside the scheduling time interval of the second type traffic; or
not sending the predetermined pilot signal within the scheduling time interval of the second type traffic, and sending the predetermined pilot signal on the periodic symbol positions configured outside the scheduling time interval of the second type traffic, wherein the periodic symbol positions are within the scheduling time interval of the first type traffic.

45. The base station according to claim 44, wherein a sending position of the indication signal in within the scheduling time interval of the first type traffic and has an appointed relative relationship with the scheduling time interval of the second type traffic,
wherein the appointed relative relationship comprises that: the sending position of the indication signal is on a pth symbol after the scheduling time interval of the second type traffic or on a qth basic time interval after the second type traffic.

46. The base station according to claim 42, wherein the first type traffic is enhanced mobile broadband (eMBB) traffic, and the second type traffic is ultra-reliable and low latency communications (URLLC) traffic.

47. A user equipment, comprising:
a processor; and
a memory communicably connected to the processor for storing instructions executable by the processor,
wherein the user equipment is configured to perform the data transmission method according to claim 21.
